(19) United States
(12) Patent Application Publication
(10) Pub. No.: US 2016/0288134 A1
(43) Pub. Date: Oct. 6, 2016

(54) MOBILE SIZER WITH REDUCED FINES GENERATION

(71) Applicant: Joy MM Delaware, Inc., Wilmington, DE (US)

(72) Inventors: Charles M. Anderson, JR., Paris, KY (US); Charles W. Watson, Paris, KY (US); Brett W. Rhea, Lexington, KY (US)

(21) Appl. No.: 15/086,688

(22) Filed: Mar. 31, 2016

Related U.S. Application Data
(60) Provisional application No. 62/140,655, filed on Mar. 31, 2015.

(51) Int. Cl. B02C 21/02; B02C 23/08; B07B 1/00; B02C 4/08

(52) U.S. Cl. CPC B02C 21/026; B02C 4/08; B02C 23/08; B07B 1/005

(57) ABSTRACT

An underground mobile sizer includes a frame, a crawler coupled to the frame and operable to move the underground mobile sizer, a feeder coupled to the frame and configured to receive a material, and a crusher coupled to the frame and operable to reduce a size of the material received by the feeder. The feeder further includes a conveyor operable to move the material towards the crusher. The conveyor includes a first end, a second end adjacent the crusher, and a screen section located between the first and second ends. The underground mobile sizer also includes a belt conveyor positioned beneath the screen section and the crusher. The belt conveyor is configured to receive material that travels through the screen section and the crusher, wherein material below a predetermined size passes through the screen section to the belt conveyor without passing through the crusher.

### CROSS-REFERENCE TO RELATED APPLICATIONS

This application claims priority to co-pending U.S. Provisional Patent Application No. 62/140,655 filed on Mar. 31, 2015, the entire contents of which are incorporated herein by reference.

### BACKGROUND

The present invention relates to a mobile sizer, in particular, an underground mobile sizer with reduced fines generation.

### SUMMARY

In one embodiment, the invention provides an underground mobile sizer including a frame, a crawler coupled to the frame and operable to move the underground mobile sizer, a feeder coupled to the frame and configured to receive a material, and a crusher coupled to the frame and operable to reduce a size of the material received by the feeder. The feeder further includes a conveyor operable to move the material towards the crusher. The conveyor includes a first end, a second end adjacent the crusher, and a screen section located between the first and second ends. The underground mobile sizer also includes a belt conveyor positioned beneath the screen section and the crusher. The belt conveyor is configured to receive material that travels through the screen section and the crusher, wherein material below a predetermined size passes through the screen section to the belt conveyor without passing through the crusher.

In another embodiment, the invention provides an underground mobile sizer including a frame, a crawler coupled to the frame and operable to move the underground mobile sizer, a feeder coupled to the frame and including a hopper to receive a material, and a crusher coupled to the frame and operable to reduce a size of the material received by the feeder. The feeder further includes a conveyor oriented at an angle to elevate the material above the crusher. The conveyor includes a screen section located between the hopper and the crusher. The underground mobile sizer also includes a tailpiece coupled to the frame. The tailpiece supports a belt conveyor positioned beneath the screen section and the crusher. The belt conveyor receives material that travels through the screen section and the crusher, wherein material below a predetermined size passes through the screen section to the belt conveyor without passing through the crusher.

Other aspects of the invention will become apparent by consideration of the detailed description and accompanying drawings.

### BRIEF DESCRIPTION OF THE DRAWINGS

FIG. 1 is a perspective view of an underground mobile sizer in accordance with an embodiment of the invention.

FIG. 2 is a side view of the underground mobile sizer of FIG. 1.

FIG. 3 is a top view of the underground mobile sizer of FIG. 1.

FIG. 4 is a detailed view of a screen section supporting a conveyor of the underground mobile sizer of FIG. 1.

FIG. 5 is a detailed view of the screen section of FIG. 4 with the conveyor removed.

FIG. 6 is a cross-sectional view taken along lines 6-6 of FIG. 3.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

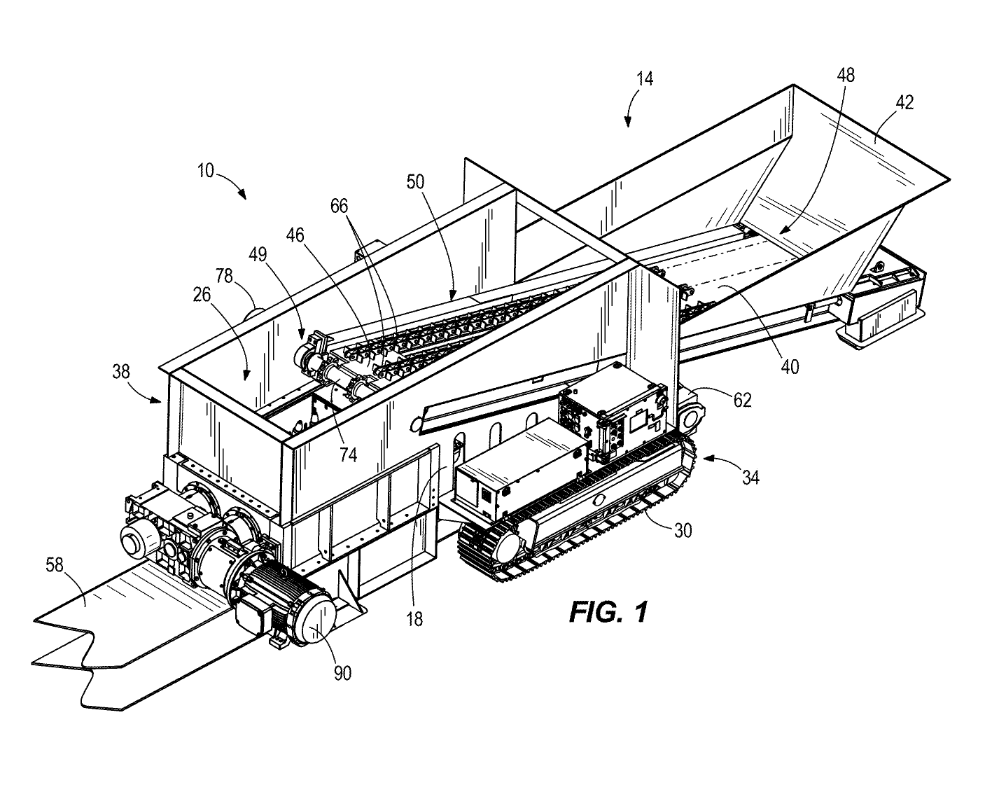

With reference to FIGS. 1-6, an underground mobile sizer 10 is illustrated having a feeder 14, a frame 18, and a crusher 26. The frame 18 is mounted on two crawlers 30 for mobility. In other embodiments, the mobile sizer 10 may be an above ground mobile sizer. Alternatively, the crawlers 26 could be replaced with wheels suitable for providing mobility.

With reference to FIGS. 1-3, the feeder 14 is coupled to a first end 34 of the frame 18, whereas the crusher 26 is coupled to a second end 38 of the frame 18. The feeder 14 includes a conveyor 40 and a hopper 42, with the hopper 42 configured to receive material (e.g., from a separate load, haul, dump vehicle). In the illustrated embodiment, the hopper 42 is a 3-way dump hopper. In other words, the 3-way dump hopper 42 allows material to be dumped in the feeder 14 from three different sides of the hopper 42.

With reference to FIGS. 1-5, the conveyor 40 extends between the hopper 42 and the crusher 26 and is configured to move material from the hopper 42 to the crusher 26. In the illustrated embodiment, the conveyor 40 is oriented at an inclined angle from the hopper 42 towards the crusher 26. In other words, the conveyor 40 is oriented at an angle to elevate material from the hopper 42 to a position above the crusher 26. The conveyor 40 includes a support surface 46 having a first end 48 located within the hopper 42, a second end 49 located above the crusher 26, and a screen section 50 located between the first end 48 and the second end 49. Alternatively, the screen section 50 may extend the entire length of the conveyor 40. The illustrated screen section 50 is integrated within the support surface 46 and includes a plurality of openings 54 that allows material smaller than the openings 54 to pass through (FIG. 5). In the illustrated embodiment, the screen section 50 includes six elongated openings 54 each including a width between about 50 millimeters and about 60 millimeters and a length greater than about 2,500 millimeters. In other embodiments, the width of the openings 54 may be between about 10 millimeters and about 100 millimeters, and the length of the openings 54 may be proportional to the overall length of the conveyor 40. The elongated openings 54 extend parallel to the length of the conveyor 40. In other embodiments, the openings 54 may extend perpendicular to the length of the conveyor 40 (e.g., from side to side of the conveyor 40). In further embodiments, the plurality of openings 54 may be any size to allow for a particular size of material to pass through the plurality of openings 54. In other embodiments, the plurality of openings 54 may be differently configured. For example, the plurality of openings 54 may form a square grid arrangement.

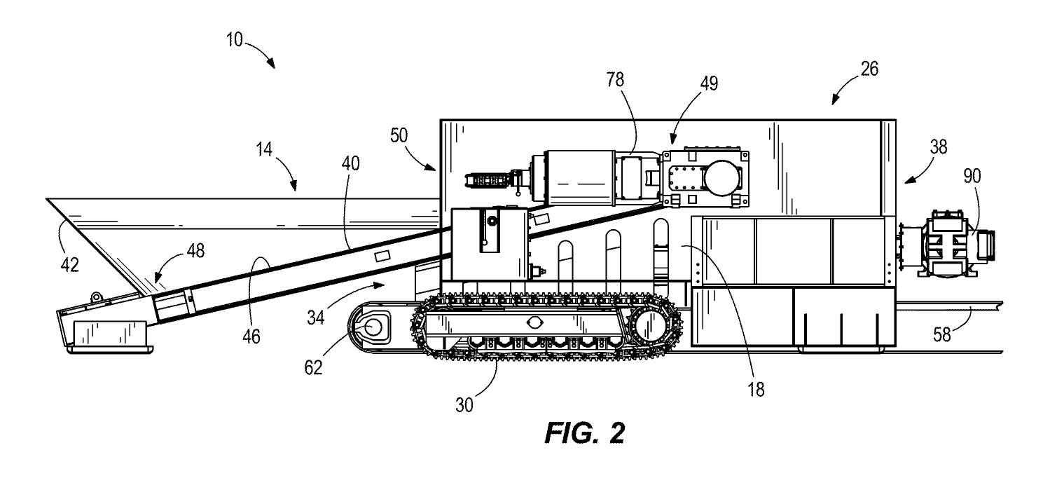

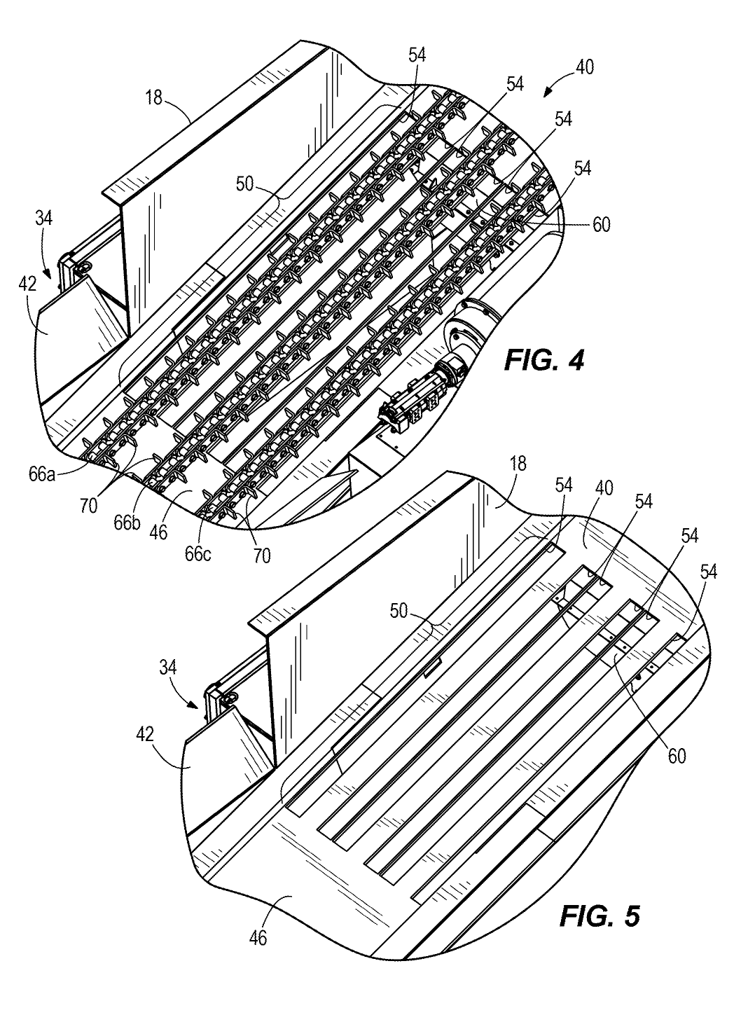

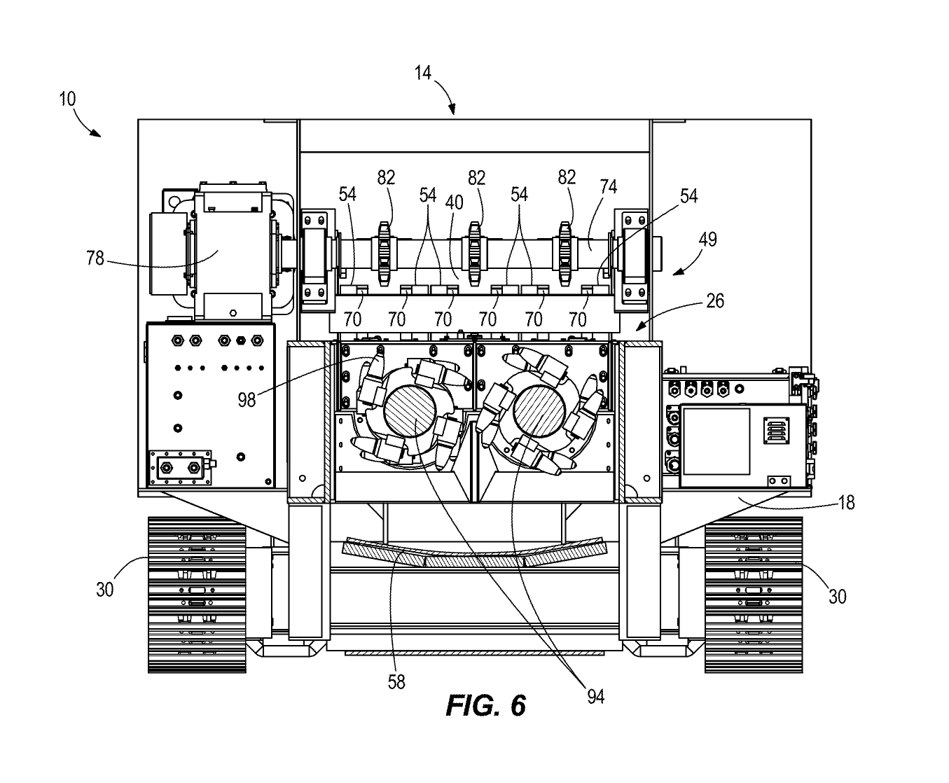

The illustrated screen section 50 is configured to allow communication between the support surface 46 of the conveyor 40 and a belt conveyor 58 (FIGS. 1 and 6) located below the conveyor 40. In addition, a portion 60 of the frame 18 located beneath the conveyor 40 is visible through the screen section 50 (FIGS. 4 and 5). In other embodiments, the portion 60 may be a portion of the crusher 26. The belt conveyor 58 is coupled to an integrated tailpiece 62 (FIG. 2) that supports and advances the belt conveyor 58 (e.g., a continuous conveyor system). The illustrated tailpiece 62 is coupled to the first end 34 of the frame 18, but in other embodiments, the tail piece 62 may be coupled to the second end 38 of the frame 18.

With reference to FIG. 4, the conveyor 40 also includes a plurality of continuous linkage members (e.g., continuous chains) 66a, 66b, 66c each having a plurality of protrusions 70 extending therefrom. Each of the continuous linkage members 66a, 66b, 66c is continuous around the support surface 46 and is moveable relative to the support surface 46 by a drive shaft 74 located adjacent the second end 49 of the conveyor 40 and above the crusher 26. In particular, the drive shaft 74 is coupled to a motor 78 and includes gears 82 that each directly mesh with one of the continuous linkage members 66. The illustrated continuous linkage members 66 are positioned such that the first linkage member 66a, the second linkage member 66b, and the third linkage member 66c are supported on the support surface 46. The continuous linkage members 66a, 66b, 66c are also positioned between the openings 54 such that the protrusions 70 extend over the openings 54. In other embodiments, the conveyor 40 may include more or less than three continuous linkage members. In the illustrated embodiment, the conveyor 40 does not include any crossbars (i.e., flight bars).

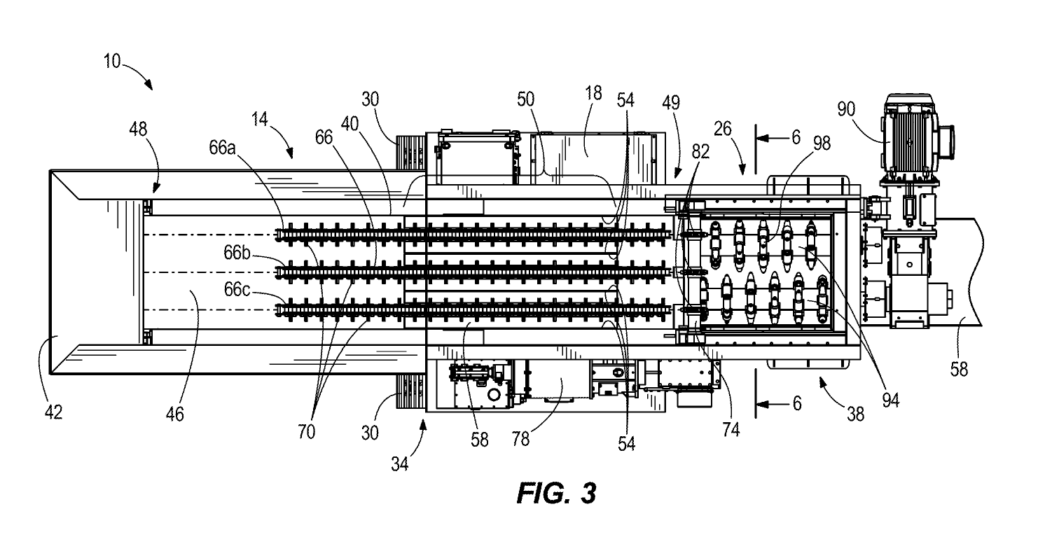

With reference to FIGS. 3 and 6, the illustrated crusher 26 is operable to reduce the size of material that falls within the crusher 26 by a drive 90 that rotates crusher drums 94 towards each other (e.g., one crusher drum 94 is rotated in a clockwise direction and the other crusher drum 94 is rotated in a counterclockwise direction). The crusher drums 94 are located between the drive shaft 74 and the belt conveyor 58. Each crusher drum 94 includes a plurality of bits 98 (e.g., carbides bits) to directly contact and fracture material that passes between the crusher drums 94. In other embodiments, the crusher 26 may include more than two crusher drums 94.

In operation, the conveyor 40 and the crusher 26 are controlled to achieve the lowest possible fines generation (i.e., small material particles that are generally considered waste). Fines, for example, are generally defined as material less than 6 mm in many underground mining applications. Material is initially received (e.g., dumped) into the feeder 14 to be collected within the hopper 42. As the drive shaft 74 rotates, the continuous linkage members 66 continuously move around the conveyor support surface 46 in the direction from the first end 48 to the second end 49. As a result, the protrusions 70 push material from the feeder 14 towards the crusher 26. When the material reaches the screen section 50, the protrusions 70 continue to push larger sized material over the openings 54 with smaller sized material falling through the openings 54 and onto the belt conveyor 58 positioned below. Stated another way, material is moved along the conveyor 40 by the continuous linkage members 66 and any material that is below a predetermined size falls through the screen section 50 without further traveling towards the crusher 26. The material larger than the openings 54 passes over the screen section 50 and is fed into the crusher 26 to be reduced to the desired size before falling onto the belt conveyor 58. In this way, the fines generated are reduced since the undersized material does not pass through the crusher 26. Passing already small-sized material through the crusher 26 tends to create even smaller-sized material. Having small-sized material pass through the screen section 50 avoids passing correctly sized and/or undersized material through the crusher 26, which creates more undersized material and fines (i.e., waste material).

Both the crusher 26 and the conveyor 40 are controlled specifically to reduce the fines generated. The continuous linkage members 66 are controlled by the drive shaft 74 and the motor 78 in order to create a variable material feed rate entering the crusher 26. Similarly, the crusher drums 94 are controlled at variable speeds by the drive 90 (i.e., variable speed breaker drums). As such, the rotational velocity of the crusher drums 94 are controlled to match the velocity of the material falling through into the crusher 26 (i.e., matched velocity technology). This minimizes wear on the crusher 26 and reduces the fines generated. When the relative speed between the crusher drums 94 and the falling speed of the material is near zero, the fines generation is minimized.

In addition, since the feeder 14, crusher 26, tailpiece 62, etc. are all mounted on the frame 18, the entire integrated underground mobile crusher 10 provides improved mobility and maneuverability. Mobility is improved by having the frame 18 supported on a single pair of crawlers 30. For example, it is easier to reposition both the crusher 26 and the feeder 14. In particular, the underground mobile sizer 10 has also been integrated to provide adequate height clearance suitable for underground mining operation.

We claim:

1. An underground mobile sizer comprising:
a frame;
a crawler coupled to the frame and operable to move the underground mobile sizer;
a feeder coupled to the frame and configured to receive a material;
a crusher coupled to the frame and operable to reduce a size of the material received by the feeder;
wherein the feeder further includes a conveyor operable to move the material towards the crusher, the conveyor including a first end, a second end adjacent the crusher, and a screen section located between the first and second ends; and
a belt conveyor positioned beneath the screen section and the crusher, the belt conveyor configured to receive material that travels through the screen section and the crusher;
wherein material below a predetermined size passes through the screen section to the belt conveyor without passing through the crusher.

2. The underground mobile sizer of claim 1, wherein the screen section includes a plurality of openings, and wherein the plurality of openings are sized to allow for material smaller than the plurality of openings to pass through and onto the belt conveyor.

3. The underground mobile sizer of claim 2, wherein the plurality of openings are elongated openings partially extending between the first and second ends of the conveyor.

4. The underground mobile sizer of claim 3, wherein each of the plurality of openings includes a width between about 50 millimeters and about 60 millimeters.

5. The underground mobile sizer of claim 3, wherein each of the plurality of openings includes a length greater than about 2,500 millimeters.

6. The underground mobile sizer of claim 1, wherein the screen section is integrated with a support surface of the conveyor.

7. The underground mobile sizer of claim 1, further comprising a continuous member operably coupled to a drive shaft adjacent the second end of the conveyor, wherein the continuous member is configured to move the material towards the crusher.

8. The underground mobile sizer of claim 7, wherein the conveyor defines a surface with the continuous member supported on the surface, and wherein the surface supports the continuous member over the screen section.

9. The underground mobile sizer of claim 8, wherein the continuous member includes a plurality of protrusions that extend over the plurality of openings, and wherein the protrusions are configured to move the material towards the crusher.

10. The underground mobile sizer of claim 1, wherein the belt conveyor is operably coupled to a tailpiece that is coupled to the frame.

11. The underground mobile sizer of claim 1, wherein the crusher includes a plurality of crusher drums operable by a drive, and wherein the crusher drums are controlled to rotate at a velocity to match a velocity of the material falling into the crusher from the conveyor.

12. An underground mobile sizer comprising:
a frame;
a crawler coupled to the frame and operable to move the underground mobile sizer;
a feeder coupled to the frame and including a hopper to receive a material;
a crusher coupled to the frame and operable to reduce a size of the material received by the feeder;
wherein the feeder further includes a conveyor oriented at an angle to elevate the material above the crusher, the conveyor including a screen section located between the hopper and the crusher; and
a tailpiece coupled to the frame, the tailpiece supporting a belt conveyor positioned beneath the screen section and the crusher;
wherein the belt conveyor receives material that travels through the screen section and the crusher; and wherein material below a predetermined size passes through the screen section to the belt conveyor without passing through the crusher.

13. The underground mobile sizer of claim 12, wherein the screen section includes a plurality of openings, and wherein the plurality of openings are sized to allow for material smaller than the plurality of openings to pass through and onto the belt conveyor.

14. The underground mobile sizer of claim 13, wherein the plurality of openings are elongated openings partially extending between the hopper and the crusher.

15. The underground mobile sizer of claim 14, wherein each of the plurality of openings includes a width between about 50 millimeters and about 60 millimeters.

16. The underground mobile sizer of claim 12, wherein the screen section is integrated with a support surface of the conveyor.

17. The underground mobile sizer of claim 12, further comprising a continuous member operably coupled to a drive shaft located above the crusher, wherein the continuous member is configured to move the material towards the crusher.

18. The underground mobile sizer of claim 17, wherein the conveyor defines a surface with the continuous member supported on the surface, and wherein the surface supports the continuous member over the screen section.

19. The underground mobile sizer of claim 18, wherein the continuous member includes a plurality of protrusions that extend over the plurality of openings, and wherein the protrusions are configured to move the material towards the crusher.

20. The underground mobile sizer of claim 12, wherein the crusher includes a plurality of crusher drums operable by a drive, and wherein the crusher drums are controlled to rotate at a velocity to match a velocity of the material falling into the crusher from the conveyor.
